(19) United States
(12) Patent Application Publication
(10) Pub. No.: US 2016/0154277 A1
(43) Pub. Date: Jun. 2, 2016

(54) BACKLIGHT AND DISPLAY APPARATUS

(71) Applicant: Mitsubishi Electric Corporation, Tokyo (JP)

(72) Inventor: Hiroshi TERAMOTO, Tokyo (JP)

(73) Assignee: Mitsubishi Electric Corporation, Tokyo (JP)

(21) Appl. No.: 14/918,994

(22) Filed: Oct. 21, 2015

(30) Foreign Application Priority Data
Nov. 28, 2014 (JP) 2014-240933

(51) Int. Cl. G02F 1/1335

(52) U.S. Cl. CPC G02F 1/133608

(57) ABSTRACT

A backlight includes a frame and a frame that engages with the frame. The frame has a groove into which a plate is fitted. The frame further has an opening for allowing the plate to pass therethrough to fit the plate into the groove.

### BACKGROUND OF THE INVENTION

1. Field of the Invention

The present invention relates to a backlight and a display apparatus having a distinctive structure.

2. Description of the Background Art

In general, a conventional liquid crystal display apparatus includes a display panel including two substrates and a planar light source device that emits light to the display panel. The planar light source device mainly includes a front frame, a middle frame, a rear frame, a light source that emits light, a light guide plate, and optical sheets. The front frame, the middle frame, and the rear frame are made of, for example, metal or resin. The light guide plate and the optical sheets have the function of changing the intensity distribution of light emitted by the light source.

The liquid crystal panels in recent years are becoming thinner and lighter and include narrower frames. Thus, the thickness of metals included in such liquid crystal display apparatus has been minimized. The thickness of the resin frame that fixes the peripheral members and the thickness of other components of the liquid crystal display apparatus including the light guide plate have also been minimized. Consequently, such liquid crystal display apparatus has a reduced stiffness in some cases. The liquid crystal display apparatus having a reduced stiffness is unsuitable for use in the conditions that require the mechanical strength such as the resistance to vibration and shock.

Japanese Patent Application Laid-Open No. 2013-246442 and Japanese Patent Application Laid-Open No. 2009-224207 disclose the techniques for improving the stiffness of liquid crystal display apparatuses. Japanese Patent Application Laid-Open No. 2013-246442 discloses the technique (hereinafter also referred to as “related art A”) of providing a reinforcing member in a housing of a liquid crystal display apparatus. Japanese Patent application Laid-Open No. 2009-224207 discloses the technique (hereinafter also referred to as “related art B”) of fixing a reinforcing member to the back sun ace of the backlight portion of a liquid crystal display apparatus.

In recent years, display apparatuses having the curved display surfaces for displaying images have been developed as, for example, liquid crystal display apparatuses. Thus, the stiffness of such display apparatus needs to be adjustable depending on the shape of the display surface of the display apparatus. In order to meet this demand, the display apparatus needs to be configured in such a manner to adjust the stiffness. The related art A and the related art B fail to meet the above-mentioned demand.

### SUMMARY OF THE INVENTION

The present invention has an object to provide a backlight and a display apparatus that allows for adjustment of stiffness.

The backlight according to one aspect of the present invention is configured such that a plate having an elongated shape is removably attached thereto. The backlight includes a first frame that houses a light source and a second frame that engages with the first frame. The first frame has a groove into which the plate is to be fitted. The first frame further has an opening for allowing the plate to pass therethrough to fit the plate into the groove.

In the present invention, the backlight includes the first frame and the second frame that engages with the first frame. The first frame has the groove into which the plate is to be fitted. The first frame further has the opening for allowing the plate to pass therethrough to fit the plate into the groove. Thus, the backlight is configured such that the plate having an elongated shape is removably attached thereto.

This configuration allows for adjustment of the stiffness of the backlight.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a display apparatus according to a first preferred embodiment of the present invention;

FIG. 2 is a perspective view of a display panel;

FIG. 3 is an exploded perspective view of a backlight according to the first preferred embodiment of the present invention;

FIG. 4 is a perspective view of the backlight according to the first preferred embodiment of the present invention;

FIG. 5 is a cross-sectional view of the backlight according to the first preferred embodiment of the present invention;

FIG. 6 is a perspective view of an exterior of a cover;

FIG. 7 is a cross-sectional view of a backlight having a modified configuration N1 applied thereto;

FIG. 8 is an exploded perspective view of a backlight according to a second preferred embodiment of the present invention;

FIG. 9 is an exploded perspective view of a backlight according to a first modification of the second preferred embodiment of the present invention; and

FIG. 10 is an exploded perspective view of a backlight according to a second modification of the second preferred embodiment of the present invention.

### DESCRIPTION OF THE PREFERRED EMBODIMENTS

With reference to the drawings, the following describes preferred embodiments of the present invention. In the descriptions below, the same reference signs indicate the same constituent components, which holds true for the names and functions thereof. Therefore, detailed descriptions thereof may be omitted.

The dimension, the material, and the shape of each of the constituent components and the relative arrangement thereof illustrated in the preferred embodiments can be appropriately varied depending on the configuration of the apparatus having the present invention applied thereto and on various conditions, and the present invention is not limited to such illustration. The dimension of each constituent component shown in each of the drawings may vary from the actual dimension thereof.

### First Preferred Embodiment

(Overall Configuration of Display Apparatus)

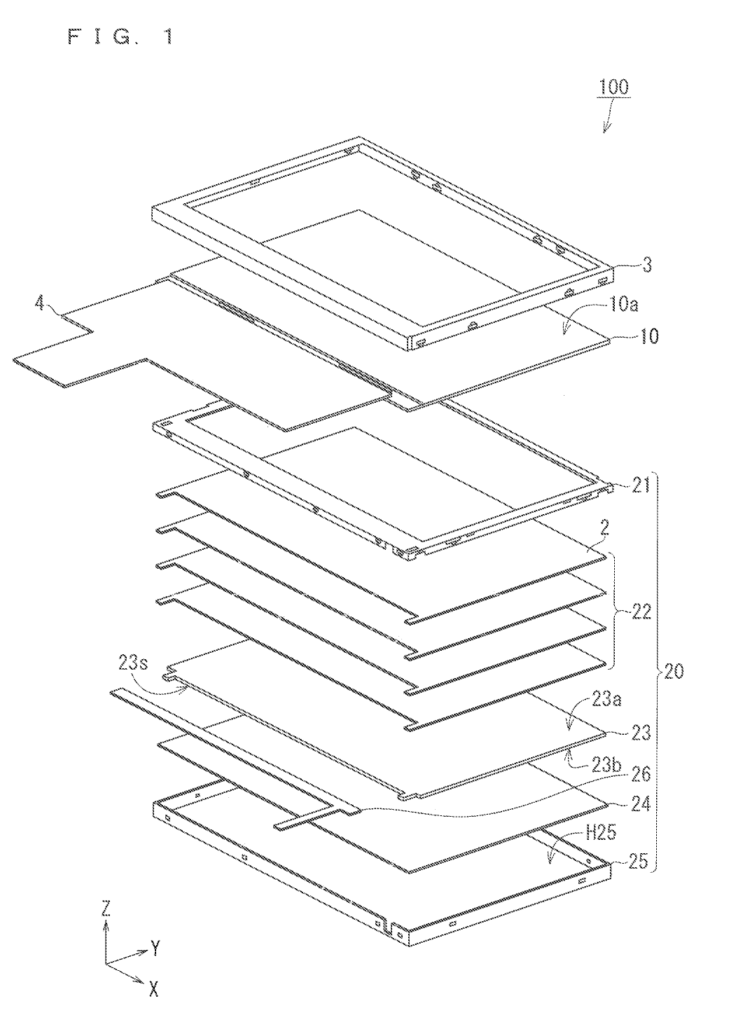

FIG. 1 is an exploded perspective view of a display apparatus 100 according to a first preferred embodiment of the present invention. The display apparatus 100 is, for example, a liquid crystal display apparatus that displays an image with liquid crystals. The display apparatus 100 is not limited to the liquid crystal display apparatus and may be a display apparatus of another scheme. For example, the liquid crystal display 100 may be a plasma display or an organic electroluminescent (EL) display.

With reference to FIG. 1, X, Y, and Z directions are orthogonal to one another. The X, Y, and Z directions indicated in the subsequent drawings are also orthogonal to one another. The direction including the X direction and the direction (−X direction) opposite to the X direction is hereinafter also referred to as “X axis direction.” The direction including the Y direction and the direction (−Y direction) opposite to the Y direction is hereinafter also referred to as “Y axis direction.” The direction including the Z direction and the direction (−Z direction) opposite to the Z direction is hereinafter also referred to as “Z axis direction.”

The plane surface including the X axis direction and the Y axis direction is hereinafter also referred to as “X-Y plane.” The plane surface including the X axis direction and the Z axis direction is hereinafter also referred to as “X-Z plane.” The plane surface including the Y axis direction and the Z axis direction is hereinafter also referred to as “Y-Z plane.”

With reference to FIG. 1, the display apparatus 100 includes a frame 3, a display panel 10, a circuit board 4, and a backlight 20.

The frame 3 is a front frame located on the front surface side of the display apparatus 100. The frame 3 has openings. The frame 3 holds the display panel 10 and the backlight 20.

The display panel 10, which will be described later in detail, displays an image on a display surface 10a included in the display panel 10. The backlight 20, which will be described later in detail, emits light toward the back surface of the display panel 10. The circuit board 4 will be described later.

On the front surface of the display panel 10, a touch panel and a protective member may be located. The touch panel is the panel that receives the touch operation performed on the display panel 10 by the user. The protective member is located so as to protect the touch panel. The protective member is a transparent member. On the back surface of the display panel 10, a cover for protecting the circuit board 4 may be located. Next, each of the above-mentioned components of the display apparatus 100 is described.

(Display Panel)

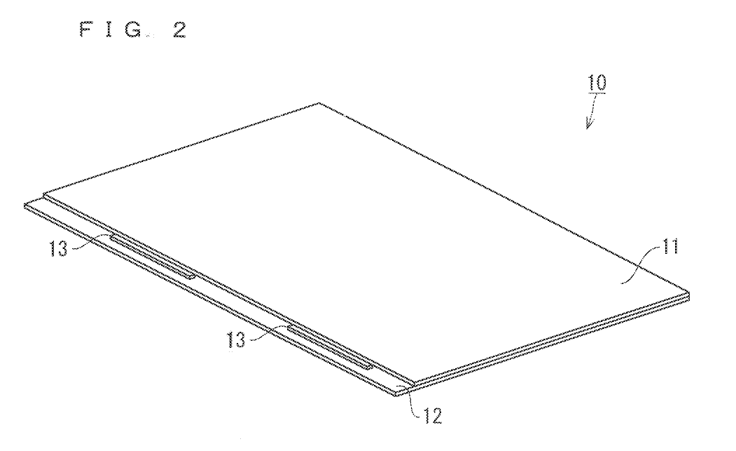

FIG. 2 is a perspective view of the display panel 10. The display panel 10 is a panel that displays an image with light emitted by the backlight 20. The display panel 10 is, for example, a transmissive or a transflective liquid crystal panel. The liquid crystal panel is the panel making use of the birefringence of the liquid crystal material. The display panel 10 includes a panel substrate 11, a panel substrate 12, and a drive circuit 13. The display panel 10 further includes a spacer, a sealing material, a liquid crystal layer, an alignment film, and polarizing plates (not shown).

The panel substrate 11 and the panel substrate 12 are insulating substrates made of, for example, glass. The panel substrate 11 is the substrate for performing the processing making use of the birefringence of the liquid crystals. In the panel substrate 11, for example, a colored layer (color filter), a light-shielding layer, and a counter electrode are formed on a substrate. In the panel substrate 12, for example, pixel electrodes including thin transistors are formed on a substrate. The thin transistors are hereinafter also referred to as “thin film transistors (TFTs).” The TFTs are the switching elements located on the substrate.

The panel substrate 11 and the panel substrate 12 are located so as to face each oilier. The spacer is located such that a given gap is formed between the panel substrate 11 and the panel substrate 12. The sealing material is the member for bonding the panel substrate 11 and the panel substrate 12 together.

The liquid crystal layer is sandwiched between the panel substrate 11 and the panel substrate 12. The liquid crystal layer is the layer including liquid crystals. In the display panel 10, a sealer is disposed in the inlet through which the liquid crystals are injected into the liquid crystal layer. The alignment film is the film for aligning liquid crystals included in the liquid crystal layer. The polarizing plates allow only the light vibrating in a specific direction to pass therethrough. The polarizing plates are located on the respective outer surfaces of the panel substrate 11 and the panel substrate 12.

The drive circuit 3 is the circuit that performs the processing for casing the display panel 10 to display an image. The drive circuit 3 is located in the peripheral portion of the panel substrate 12. The drive circuit 13 may be located on a tape-shaped wiring material connected to the peripheral portion of the panel substrate 12. The wiring material is, for example, a tape carrier package (TCP) or a chip-on film (COF).

(Backlight)

The backlight 20 emits light to the back surface of the display panel 10 (in the Z direction). As shown in FIG. 1, the backlight 20 includes frames 21 and 25, an optical sheet part 22, a light guide plate 23, a reflecting plate 24, and a light source substrate 26. The shape of each of the constituent components of the backlight 20 shown in FIG. 1 may be slightly different from the actual shape.

The frame 25 is the rear frame located on the back surface side of the display apparatus 100. The frame 25 is substantially shaped in a box having an opening H25. The frame 25 houses (holds) the frame 21, the optical sheet part 22, the light guide plate 23, the reflecting plate 24, and the light source substrate 26. The frame 21 is the middle frame located in the midsection of the backlight 20 in the thickness direction.

The light source substrate 26 includes a light source (not shown) that emits light. The light guide plate 23 guides light emitted by the light source in a specific direction. To be a little more specific, the light guide plate 23 is the member for guiding light to the optical sheep part 22. In particular, the light guide plate 23 has a light-emitting surface 23a, a counter light-emitting surface 23b, and a side surface 23s. The light-emitting surface 23a is the surface through light is emitted. The counter light-emitting surface 23b is the surface of the light guide plate 23 opposite to the light-emitting surface 23a. The counter light-emitting surface 23b is the surface from which no light is emitted.

The light emitted by the light source is propagated to the inside of the light guide plate 23 through the side surface 23s of the light guide plate 23. The light propagated to the inside of the light guide plate 23 is emitted from the light-emitting surface 23a in the Z direction. That is, the light guide plate 23 emits, from the light-emitting surface 23a, the light emitted by the light source.

The optical sheet part 22 is located on the light-emitting surface 23a of the light guide plate 23. The optical sheet part 22 includes a plurality of optical sheets 2. The optical sheet part 22 may include one optical sheet 2. The optical sheets 2 allows the light emitted from the light-emitting surface 23a (the light source) for use in image displaying to pass therethrough. That is, the portion of the optical sheet part 22 closest to the display panel 10 is the light-emitting surface that emits light. Thus, the display panel 10 is located on the light-emitting surface side of the backlight 20.

The optical sheet part 22 controls the distribution and the spread of light emitted from the light guide plate 23. The optical sheet part 22 emits, to the display panel 10, light emitted from the light-emitting surface 23a. The display panel 10 displays an image with light emitted from the light-emitting surface 23a.

The reflecting plate 24 is located on the counter light-emitting surface 23b side of the light guide plate 23. The reflecting plate 24 is the sheet that reflects light. The reflecting plate 24 is provided, so that light emitted from the light guide plate 23 in the −Z direction is reflected by the reflecting plate 24 and then reenters the light guide plate 23.

(Light Guide Plate)

The light guide plate 23 is made of a transparent material such as acrylic resin, polycarbonate resin, or glass. The light-scattering dot pattern is formed on at least one of the light-emitting surface 23a and the counter light-emitting surface 23b of the light guide plate 23. The light-scattering dot pattern has functions of adjusting, for example, the light intensity distribution and the direction of light emission. The light guide plate 23 has a wedge shape (a prism shape). The light guide plate 23 may be fixed to the frame 25 with, for example, a double-sided tape.

(Optical Sheet Part)

The optical sheet part 22 includes, depending on the purposes, a required number of for example, lens sheets, diffusion sheets, and viewing angle adjustment sheets. The lens sheets are the sheets for condensing light. The diffusion sheets are the sheets for uniforming light. The viewing angle adjustment sheets are the sheets for adjusting the brightness in the viewing angle direction. Thus, each of the optical sheets 2 included in the optical sheet part 22 is any one of the lens sheet, the diffusion sheet, and the viewing angle adjustment sheet.

As described above, the optical sheet part 22 may include one optical sheet 2. The optical sheet 2 is made of a resin material such as polycarbonate (PC) or polyethylene terephthalate (PET).

(Frame)

The frame 25 is, as mentioned above, the rear frame located on the hack surface side of the display apparatus 100. The frame 25 is made of metal having a high thermal conductivity so as to conduct heat emitted from the light source of the light source substrate 26. The metal having a high thermal conductivity is, for example, aluminum or aluminum alloy. The frame 25 made of the metal having a high thermal conductivity efficiently dissipates heat emitted from the light source of the light source substrate 26. Thus, the heat is prevented from persisting in the backlight 20.

The frame 21 is, as mentioned above, the middle frame located in the midsection of the back light 20 in the thickness direction. The frame 21 has an opening for allowing light emitted from the light-emitting surface 23a of the light guide plate 23 to pass therethrough. The display panel 10 is mounted on the upper surface of the frame 21. The display panel 10 is held by the frame 3 and the frame 21.

The frame 21 is flexible. The frame 21 is made of resin. The resin is, for example, polycarbonate (PC) or acrylonitrile butadiene styrene resin (ABS). The frame 21 is not necessarily made of resin and may be made of metal. The metal is, for example, aluminum, stainless steel, or iron.

The frame 21 engages with the frame 25 through, for example, an engaging portion (not shown). The frame 21 is thus fixed to the frame 25. The engaging portion is, for example, a claw. At least one of the frame 21 and the frame 25 has the engaging portion. The frame 21 is fixed to the frame 25, so that the optical sheet part 22, the light guide plate 23, the reflecting plate 24, and the light source substrate 26 are held by the frame 21 and the frame 25.

Alternatively, the frame 21 and the frame 25 may be fixed to each other with a screw. Still alternatively, the frame 21 and the frame 25 may be unified.

The frame 3 is, as mentioned above, the front frame located on the front surface side of the display apparatus 100. The frame 3 holds the display panel 10 and the backlight 20. The frame 3 has a closed loop shape, or equivalently, a frame shape in plan view (in the X-Y plane). The frame 3 includes, for example, a sheet metal or a resin molded product. The frame 3 is fixed to the backlight 20 with, for example, a claw-shaped fixing structure or a screw structure. The frame 3 includes a single member.

The frame 3 may include a plurality of members combined to each other. The fixing parts (such as screws or mounting holes) may be provided in, for example, the side surface, the front surface, the back surface, and the peripheral portion of the frame 3. The fixing parts are provided in, for example, a housing (not shown) of the display apparatus 100.

(Light Source)

The light source located on the light source substrate 26 is, for example, an RGB-based point light source, a light-emitting diode (LED) emitting light other than RGB light, or a fluorescent tube lamp. The RGB-based point light source is the light source emitting red light, green light, and blue light.

In a case where the point light source serves as the light source, the light source substrate 26 having the point light source located thereon mainly includes a substrate based on commonly used glass epoxy resin and a flexible flat cable.

The light source substrate 26 may be made of, for example, metal such as aluminum or ceramic so as to obtain increased thermal dissipation properties. The light source substrate 26 is bonded to, for example, the light guide plate 23 or the frame 25, this being held in the position.

(Circuit Board)

The circuit board 4 controls the display panel 10 and the light source of the light source substrate 26 with electric input-output signals. In the circuit board 4, electronic components are mounted on the flexible printed circuits (FPCs) including wiling formed on a film-shaped base material connected to the display panel 10.

Alternatively, in the circuit board 4, electronic components may be soldered and thus mounted on the surface of, for example, the glass epoxy having a copper pattern formed thereon. The circuit board 4 is principally located (fixed) on the back surface side (the non-light emitting side) of the display apparatus 100.

Optionally, a protective cover (not shown) for protecting the circuit board 4 against external pressure and static electricity may he fixed to the circuit board 4. The protective cover is made of metal such as aluminum, stainless steel, or a galvanized steel sheet, or is made of film-shaped thin resin such as polyethylene terephthalate (PET).

To allow the use of the protective cover made of metal, a sheet made of resin such as PET is bonded to the circuit board 4, keeping the circuit board 4 from electrical contact with the electronic components on the circuit board 4. This provides insulating measures.

(Distinctive Configuration)

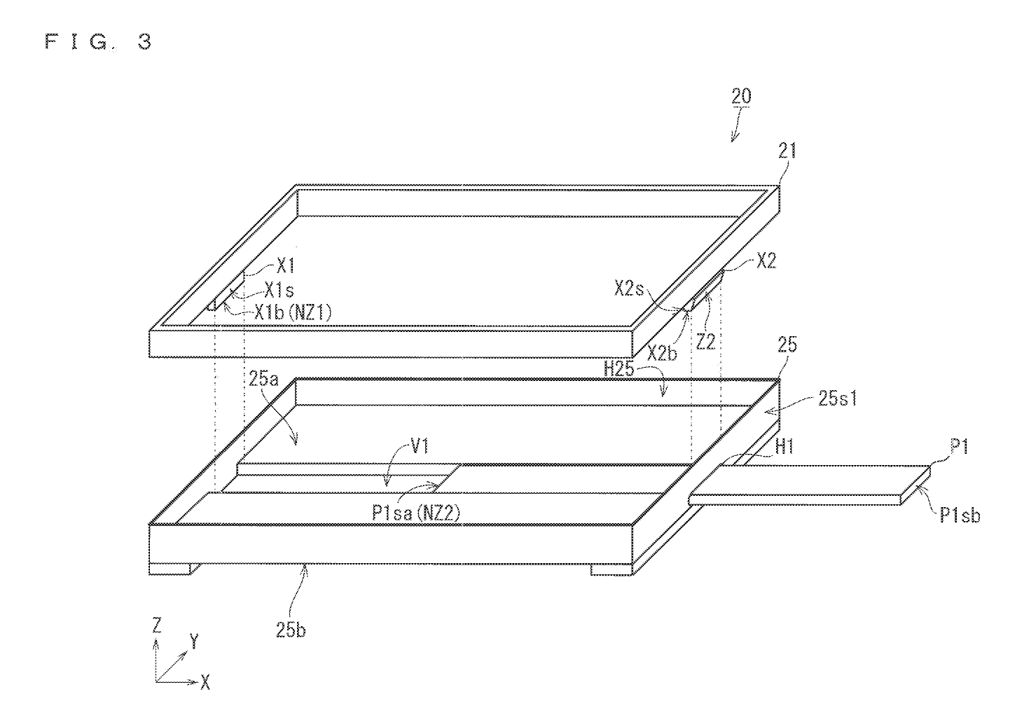

The following describes, in detail, a distinctive configuration (hereinafter also referred to as “distinctive configuration A1”) in this preferred embodiment. FIG. 3 is an exploded perspective view of the backlight 20 according to the first preferred embodiment of the present invention. FIG. 3 shows only the distinctive constituent components of the backlight 20. The distinctive constituent components are the frames 21 and 25. To provide easy-to-understand illustration of the distinctive configuration A1, the optical sheet part 22, the light guide plate 23, the reflecting plate 24, and the light source substrate 26 included in the backlight 20 are omitted in FIG. 3.

To provide the easy-to-understand illustration of the distinctive configuration A1, the shapes of the frame 21 and 25 are simplified in FIG. 3. Thus, the shapes of the frames 21 and 25 in FIG. 3 are slightly different from the actual shapes. To provide the easy-to-understand illustration of the distinctive configuration A1, FIG. 3 illustrates the state in which a part of a plate P1 described below is fitted into a groove V1 described below.

With reference to FIG. 3, the backlight 20 is configured such that the plate P1 having an elongated shape is removably attached thereto and this configuration will he described later in detail. The plate P1 is the member for adjusting the stiffness of the backlight 20. The plate P1 has a plate shape or a rod shape.

The plate P1 is made of a material having a stiffness higher than that of the material of the frame 25. In particular, the plate P1 is made of any one of stainless steel, aluminum (Al), steel, and magnesium (Mg). Alternatively, the plate P1 may be made of carbon fiber resin composed of carbon fiber and resin. The carbon fiber resin is lighter and stiffer. Thus, the use of the plate P1 made of carbon fiber resin is effective at improving the stiffness of the backlight 20.

The state in which the plate P1 is attached to the backlight 20 is hereinafter also referred to as “attached state Pst.” The state in which the plate P1 is not attached to the backlight 20 is hereinafter also referred to as “detached state Pnst.” The plate P1 in the attached state Pst is the reinforcing member that increases the stiffness of the backlight 20 compared to that of the backlight 20 in the detached state Pnst.

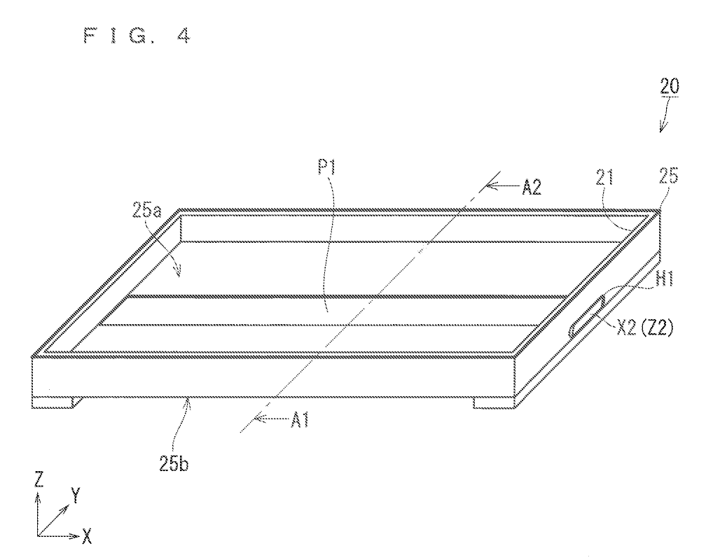

FIG. 4 is a perspective view of the backlight 20 according to the first preferred embodiment of the present invention. In particular, FIG. 4 is a perspective view of the backlight 20 in the attached state Pst. Similarly to FIG. 3, FIG. 4 shows only the distinctive constituent components of the backlight 20 in order to provide easy-to-understand illustration of the distinctive configuration A1. The backlight 20 has a rectangular shape in plan view (in the X-Y plane). Thus, the backlight 20 has long sides and short sides defining the rectangle.

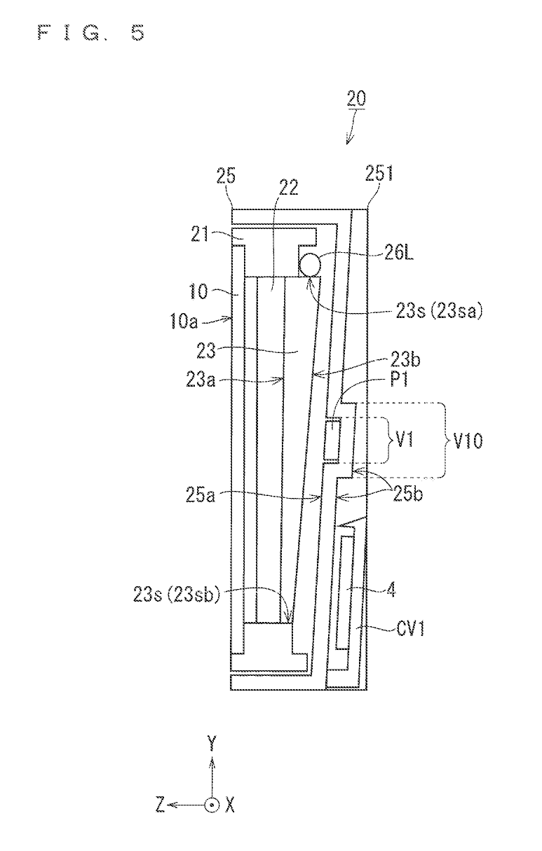

FIG. 5 is a cross-sectional view of the backlight 20 according to the first preferred embodiment of the present invention. In particular, FIG. 5 is across-sectional view of the backlight 20 taken along line A1-A2 in FIG. 4. With reference to FIG. 5, the shape of each constituent component of the backlight 20 is simplified, FIG. 5 also shows the constituent components (such as the display panel 10 and the circuit board 4) that are not included in the backlight 20. FIG. 5 also shows a light source (hereinafter also referred to as “light source 26L”) located on the light source substrate 26 in FIG. 1.

With reference to FIGS. 3, 4, and 5, the frame 25 has a main surface 25a and a back surface 25b. The main surface 25a is the undersurface of the frame 25 having the opening H25. The back surface 25b is the surface of the frame 25 opposite to the main surface 25a.

The frame 25 has the groove VI. In particular, the main surface 25a (the undersurface) of the frame 25 has the groove V1. The groove V1 is the groove into which the plate P1 is to be fitted. The groove V1 has a shape for housing the plate P1. In other words, the cross section of the plate P1 has the shape substantially identical to the shape of the cross section of the groove V1. The longitudinal length of the groove V1 (in the X axis direction) is slightly greater than the longitudinal length of the plate P1.

The groove V1 is provided so as to extend along the long side of the backlight 20. The groove V1 is provided in the midsection of the frame 25 in the Y axis direction. Thus, the groove V1 is provided, in the midsection of the backlight 20 in the Y axis direction.

As shown in FIG. 5, the groove V1 is provided in such a manner that the portion (hereinafter also referred to as “groove presence portion”) of the frame 25 having the groove V1 provided therein projects on the back surface 25b side.

As shown in FIG. 5, the light guide plate 23 has a wedge shape as mentioned above. The light guide plate 23 has the light-emitting surface 23a, the counter light-emitting surface 23b, and the side surface 23s as mentioned above. The side surface 23s of the portion of the light guide plate 23 having the greatest thickness is hereinafter also referred to as “light incident surface 23sa.” The side surface 23s of the portion of the light guide plate 23 having the smallest thickness is hereinafter also referred to as “counter light-incident surface 23sb.”

As show in FIG. 5, the light source 26L is located on the light incident surface 23sa side of the light guide plate 23. Thus, light emitted by the light source 26L enters the light incident surface 23sa. As an example, the light source 26L is an LED. The LED has a life longer than that of for example, a fluorescent tube lamp. The frame 25 houses the light source 26L.

The light guide plate 23 has a shape for increasing the utilization efficiency of light emitted from the light source 26L. Thus, the light guide plate 23 is shaped in such a manner that the light guide plate 23 has the largest thickness on the light incident surface 23sa side and the light guide plate 23 has the smallest thickness on the counter light-incident surface 23sb side.

As shown in FIG. 5, the light emitting surface 23a of the light guide plate 23 is parallel with the display surface 10a of the display panel 10. Meanwhile, a tapering portion is provided on the counter light-emitting surface 23b side of the light guide plate 23 (on the main surface 25a side of the frame 25). Thus, the light guide plate 23 has the counter light-emitting surface 23b inclined in the Y axis direction. The direction in which the inclined counter light-emitting surface 23b of the light guide plate 23 extends is hereinafter also referred to as “inclination direction.” The inclination direction is the direction obtained by inclining the Y axis direction.

As shown in FIG. 5, the main surface 25a and the back surface 25b of the frame 25 are inclined from the Y axis direction so as to agree with the shape of the light guide plate 23. The thickness of one edge (hereinafter also referred to as “minimum thickness edge”) of the frame 25 in the Y axis direction is smaller than the thickness of another edge of the frame 25 in the Y axis direction. The minimum thickness edge of the frame 25 is the lower edge of the frame 25 in FIG. 5.

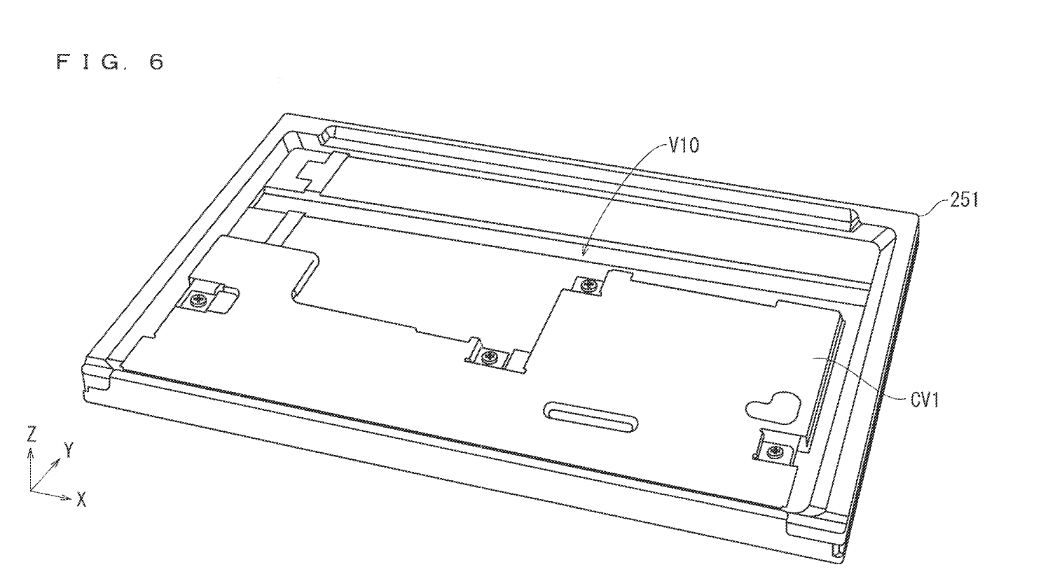

A cover 251 is located in the peripheral portion of the back surface 25b of the frame 25. That is, the cover 251 that covers the back surface 25b is fixed to the frame 25. The actual shape of the cover 251 is simplified in FIG. 5. FIG. 6 is a perspective view of the exterior of the cover 251. The cover 251 is the planarization module for parailelizing the display surface 10a with X-Y plane when the backlight 20 (the display apparatus 100) is placed on the flat surface.

With reference to FIGS. 5 and 6, the cover 251 has a recess. The recess of the cover 251 mainly houses the circuit board 4 and a protective cover CV1. As shown in FIG. 5, the circuit board 4 is located on the minimum-thickness-edge side of the frame 25. The protective cover CV1 is located so as to cover the circuit board 4.

The peripheral portion of the cover 251 is inclined along the Y axis direction so as to be connected to the back surface 25b having a tilt. The thickness of the thinnest portion of the cover 251 is hereinafter also referred to as “minimum thickness CTh.”

The groove V1 of the frame 25 is formed in such a manner that the groove presence portion of the frame 25 does not protrude from the cover 251. In particular, the groove V1 has a depth smaller than the thickness (the minimum thickness CTh) of the cover 251.

As shown in FIG. 3, the groove V1 extends linearly in the X axis direction (along the long side of the backlight 20) orthogonal to the Y axis direction. The groove V1 extends from one edge to another edge of the main surface 25a (the under surface) of the frame 25.

The groove V1 has any width, for example, in the 2 to 50 mm range. The groove V1 has any depth, for example, in the 2 to 5 mm range.

The undersurface of the recess of the cover 251 has a groove V10. As shown in FIG. 5, the groove V10 is provided so as to house the groove presence portion of the frame 25. With reference to FIG. 6, the groove V10 is shown in an easy-to-see position. in actuality, the groove V10 is provided in the midsection of the cover 251 in the Y axis direction.

The frame 25 further has an opening H1. In particular, as shown in FIG. 3, the frame 25 further has a side surface 25s1. The side surface 25s1 has the opening H1. The opening H1 is the opening for allowing the plate P1 to pass therethrough to fit the plate P1 into the groove V1.

The edge portion of the groove V1 on one side is hereinafter also referred to as “groove edge portion V1a.” The groove edge portion V1a is, for example, the left edge portion of the groove V1 in FIG. 3. The edge portion of the groove V1 on another side is hereinafter also referred to as “groove edge portion V1b.” The groove edge portion V1b is, for example, the right edge portion in FIG. 3. The peripheral portion of the frame 25 (the side surface 25s1) that is in contact with the opening H1 is hereinafter also referred to as “opening peripheral portion.”

The frame 21 includes projecting portions X1 and X2. The projecting portion X1 is the portion which is to be fitted into the groove edge portion V1a. The projecting portion X1 has a side surface X1s and an undersurface X1b. The side surface X1s is the plane surface of the projecting portion X1 facing the projecting portion X2. The undersurface X1b is the plane surface facing the undersurface of the groove edge portion V1a. Thus, the surface of the frame 21 that is in contact with a part of the frame 25 is flat.

The projecting portion X2 is the portion which is to be fitted into the groove edge portion V1b. The projecting portion X2 has a side surface X2s, an undersurface X2b, and a projection Z2 (a claw). The side surface X2s is the plane surface of the projecting portion X2 facing the projecting portion X1. The undersurface X2b is the plane surface facing the undersurface of the groove edge portion V1b. The projection Z2 has a shape for engaging with the opening peripheral portion of the frame 25 from inside the frame 25. Thus, the projection Z2 is to be inserted into the opening H1 of the frame 25 from inside the frame 25. As an example, the projection Z2 shown in FIG. 3 projects in the X direction. The projecting portion X2 is flexible in such a manner that the projection Z2 can move slightly in the X axis direction. As an example, the length of the projection Z2 in the Z direction is slightly smaller than the length of the opening H1 in the Z direction.

The projection Z2 engages with the opening peripheral portion of the frame 25, so that the frame 21 engages with the frame 25. Thus, the frame 21 is fixed to the frame 25. The state in which the frame 21 is fixed to the frame 25 is hereinafter also referred to as “frame fixation state.” The frame fixation state in the first preferred embodiment is hereinafter also referred to as “frame fixation state Fst1.”

The frame fixation state Fst1 is the state in which the projecting portion X1 is fitted in the groove edge portion V1a and the projecting portion X2 is fitted in the groove edge portion V1b. The frame fixing state Fst1 is the state in which the projection Z2 engages with the opening peripheral portion of the frame 25. Thus, the frame fixation state Fst1 refers to the state in which the frame 21 and the frame 25 are as shown in FIG. 4.

FIG. 4 shows the state of the plate P1 in the attached state Pst mentioned above. The attached state Pst is, as mentioned above, the state in which the plate P1 is attached to the backlight 20. In particular, the attached state Pst is the state in which the plate P1 as a whole is fitted in the groove V1.

The plate P1 has side surfaces P1sa and P1sb, The side surface P1sa is the surface that is in contact with the site surface X1s of the projecting portion X1 in the frame fixation Fst1 state and the attached state Pst. In the frame fixation state Fst1 and the attached state Pst, the side surface P1sa is fixed to the side surface X1s of the projecting portion X1 with an adhesive material NZ2. The adhesive material NZ2 is, for example, a double-sided tape. Thus, in the frame fixation state Fst1 and the attached state Pst, the edge (the side surface P1sa) of the plate P1 is fixed to the projecting portion X1 being a part of the frame 21 with the adhesive material NZ2. This improves the stiffness of the backlight 20.

The side surface P1sh is the surface that is in contact with the side surface X2s of the projecting portion X2 in the frame fixation state Fst1 and the attached state Pst.

The following describes a process (hereinafter also referred to as “plate process”) for fitting the plate P1 into the groove V1. The plate process in the first preferred embodiment is hereinafter also referred to as “plate process S1.”

Prior to the plate process (the plate process S1), a frame fixation process is performed, in the frame fixation process, as shown in FIG. 3, an adhesive material NZ1 is provided on the undersurface X1b of the projecting portion X1. The adhesive material NZ1 is, for example, a double-sided tape. Then, the frame 21 is fixed to the frame 25 in such a manner that the projecting portion X1 is fitted in the groove edge portion V1a and the projecting portion X2 is fitted in the groove edge portion V1b.

Consequently, the undersurface X1b of the projecting portion X1 is fixed to the undersurface of the groove edge portion V1a with the adhesive material NZ1. The state in which the undersurface X1b of the projecting portion X1 is fixed to the undersurface of the groove edge portion Via is hereinafter also referred to as “projecting portion fixation state.”

The projection 72 of the projecting portion X2 engages with the opening peripheral portion of the frame 25 from inside the frame 25. Consequently, the frame 21 is brought into the frame fixation state Fst1 mentioned above.

The adhesive material NZ1 is not necessarily provided on the undersurface X1b. Alternatively, the adhesive material NZ1 may be provided on the groove edge portion V1a. Still alternatively, the adhesive material NZ1 may be omitted. In such configuration, the projecting portion X1 becomes caught in the groove edge portion V1a (the groove V1), and thus, the projecting portion X1 is fixed to the groove edge portion V1a.

Next, the plate process S1 is performed. The plate process S1 includes a disengaging process, a plate moving process, and reengaging process. The disengaging process is firstly performed.

In the disengaging process, the operator presses the projecting portion X2 in the in the −X direction so as to terminate the state in which the projection Z2 of the projecting portion X2 engages with the opening peripheral portion of the frame 25. Then, while maintaining the projecting portion fixation state, the operator moves the right side portion of the frame 21 slightly in the Z direction (upward) such that the projecting portion X2 is no longer present in the opening H1.

Next, the plate moving process is performed. In the plate moving process, the adhesive material NZ2 is provided on the side surface Pisa of the plate P1. Then, the operator moves the plate P1 such that the plate P1 passes through the opening H1 and the plate P1 as a whole is fitted into the groove V1. Consequently, the side surface P1sa of the plate P1 is fixed to the side surface X1s of the projecting portion X1 with the adhesive material NZ2.

Then, the reengaging process is performed. In the reengaging process, the right side portion of the frame 21 is moved in the −Z direction (downward) such that the projection Z2 of the projecting portion X2 engages with the opening peripheral portion of the frame 25. Consequently, the backlight 20 is as shown in FIGS. 4 and 5. Thus, the frame 21 is brought into the frame fixation state Fst1. The plate P1 is brought into the attached state Pst. FIG. 5 shows the configuration of the plate P1 in the attached state Pst.

The following describes a process (hereinafter also referred to as “plate detaching process”) of detaching the plate P1 in the attached state Pst from the groove V1. The plate detaching process is performed while the plate P1 is in the attached state Pst.

In the plate detaching process, the disengaging process mentioned above is firstly performed. Consequently, the projecting portion X2 is no longer present in the opening H1.

Next, the operator pulls the plate P1 through the opening Hi such that the plate P1 as a whole is detached from the groove V1. Consequently, the plate P1 is removed from the groove V1. Then, the above-mentioned reengaging process is performed.

(Effects)

In this preferred embodiment, as described above, the backlight 20 includes the frame 25 and the frame 21 that engages with the frame 25. The frame 25 has the groove V1 into which the plate R1 is to be fitted. The frame 25 further has the opening H1 for allowing the plate P1 to pass therethrough to fit the plate P1 into the groove V1. Thus, the backlight is configured such that the plate P1 having an elongated shape is removably attached thereto.

Thus, the stiffness of the backlight can he adjusted. In particular, the stiffness of the backlight 20 (the frame 25) can be adjusted through the plate process S1 or the plate detaching process mentioned above.

In this preferred embodiment, as shown in FIG. 5, the frame 25 has the groove V1 in such a manner that the shape of the cross section of the frame 25 being the rear frame changes in the thickness direction. This improves the stiffness of the frame 25 (the backlight 20) in the extending direction of the groove V1 (in the X axis direction).

In this preferred embodiment, while being fitted in the groove V1, the plate P1 is fixed by the projecting portions X1 and X2 of the frame 21, the groove V1 of the frame 25, and the light guide plate 23 with a slight clearance left therebetween. Thus, the plate P1 is integrated into the frame 25, providing the structure capable of eliminating or reducing deformations of the frame 25 (the backlight 20) due to bending.

In this preferred embodiment, the plate P1 is made of a material having a stiffness higher than that of the frame 25. Thus, the flexural stiffness owing to the thickness of the plate P1 is added to the stiffness of the frame 25. This can improve the stiffness of the frame 25. Thus, the backlight 20 has an improved stiffness in flexure.

In this preferred embodiment, the groove V1 is provided in the midsection of the backlight 20. With this configuration, the plate P1 is fitted into the groove V1. Thus, the backlight 20 in this preferred embodiment is effective against the mode of vibration in which the midsection of the frame 25 vibrates. Depending on the use intended by the end user, the plate P1 is attached to or detached from the backlight 20, thereby adjusting the stiffness of the backlight 20. The stiffness can be adjusted during the assembly of the backlight 20. Thus, in this preferred embodiment, the stiffness suited to the above-mentioned intended use can be achieved by the minimum component being the plate P1.

According to the related art A, the reinforcing member is provided in the housing of the liquid crystal display as mentioned above. Thus, the housing of the liquid crystal display apparatus needs to have a space for the reinforcing member. Unfortunately, this increases the thickness of the liquid crystal display apparatus.

In a case where the liquid crystal display apparatus according to the related art A does not include the reinforcing member, a space is left between the light guide plate and the frame, and thus, display irregularities mainly occurs due to bending. The related art A is based on the premise that the reinforcing member is used. Thus, with the related art A, the stiffness (strength) of the liquid crystal display apparatus cannot be easily adjusted depending on circumstances where the low stiffness is tolerated or the high stiffness is required.

The related art B is, as mentioned above, the technique of fixing the reinforcing member o the back surface of the backlight portion of the liquid crystal display apparatus. The related art B requires, as the structure for fixing the reinforcing member, the structure with an adhesive tape or the screw structure with a screw.

Unfortunately, the adhesion of the adhesive tape decreases in an extended period of use. If the liquid crystal display apparatus including the reinforcing member fixed with the adhesive tape is used for a long period of time, the reinforcing member would fall off.

The above-mentioned screw structure requires the additional processing of the structure for screwing and the additional assembly work through screwing. This would increase the costs.

These problems can be resolved through the above-mentioned configuration of this preferred embodiment. For example, in this preferred embodiment, the stiffness of the backlight 20 (the display apparatus 100) can be optionally adjusted. In this preferred embodiment, the simple configuration (easy configuration) through the use of the plate P1 mainly prevents the reinforcing member from falling off as mention above. This provides the backlight 20 (the display apparatus 100) of high reliability.

In this preferred embodiment, the light guide plate 23 has a wedge shape, which is not limited thereto. In another configuration (hereinafter also referred to as “modified configuration N1”), the light guide plate 23 may have a fiat plate shape. The backlight 20 having the modified configuration N1 applied thereto is hereinafter also referred to as “backlight 20N.”

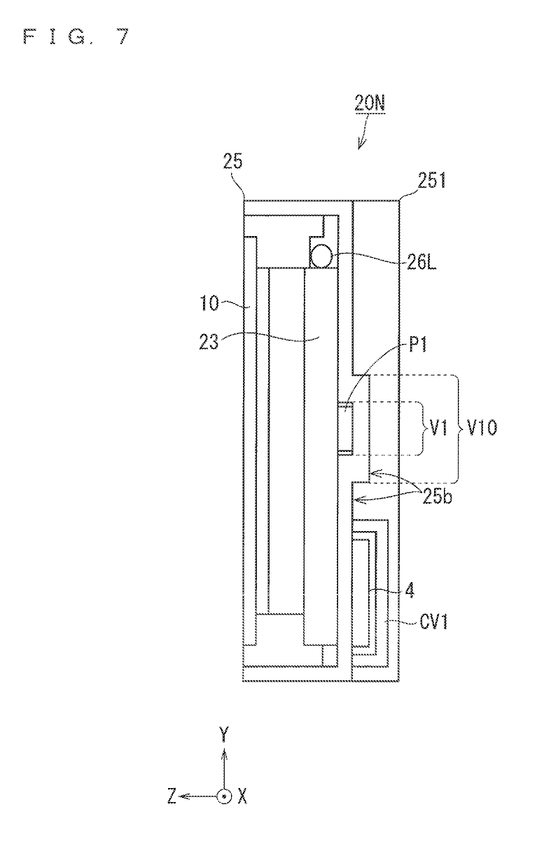

FIG. 7 is a cross-sectional view of the backlight 20N having the modified configuration N1 applied thereto. Similarly to FIG. 5, FIG. 7 shows the constituent components (such as the display panel 10 and the circuit board 4) that are not included in the backlight 20N.

The backlight 20N differs from the backlight 20 in FIG. 5 in that the cover 251 located on the back surface 25b has a different shape and the back surface 25b of the frame 25 is parallel with the X-Y plane. The configuration of the backlight 20N except for the above is the same as that of the backlight 20 in FIG. 5, and the detailed description thereof is not repeated.

In the modified configuration N1, the portion of the cover 251 that is connected to the frame 25 is parallel with the X-Y plane. In the modified configuration N1, the groove V1 of the frame 25 is formed in such a manner that the groove presence portion of the frame 25 does not protrude from the cover 251. In particular, the groove V1 has a depth smaller than the thickness of the cover 251. The depth of the groove V1 is set to reflect the height of the position of the circuit board 4.

The modified configuration N1 can also improve the stiffness of the display apparatus 100 through the above-mentioned configuration without increasing the thickness (the outside shape) of the display apparatus 100.

In this preferred embodiment, the edge (the side surface P1sa) of the plate P1 is fixed to the projecting portion X1 being a part of the frame 21 with the adhesive material NZ 2. In another configuration (hereinafter also referred to as “modified configuration N2”), the adhesive material NZ2 is not used. In the modified configuration N2, the edge (the side surface P1sa) of the plate P1 comes in contact with the projecting portion X1 being a part of the frame 21.

### Second Preferred Embodiment

In this preferred embodiment (hereinafter also referred to as “modified configuration A”), a plurality of plates are used. The backlight 20 having the modified configuration A applied thereto is hereinafter also referred to as “backlight 20A.” The display apparatus in this preferred embodiment is the display apparatus 100. The display apparatus 100 includes the backlight 20A.

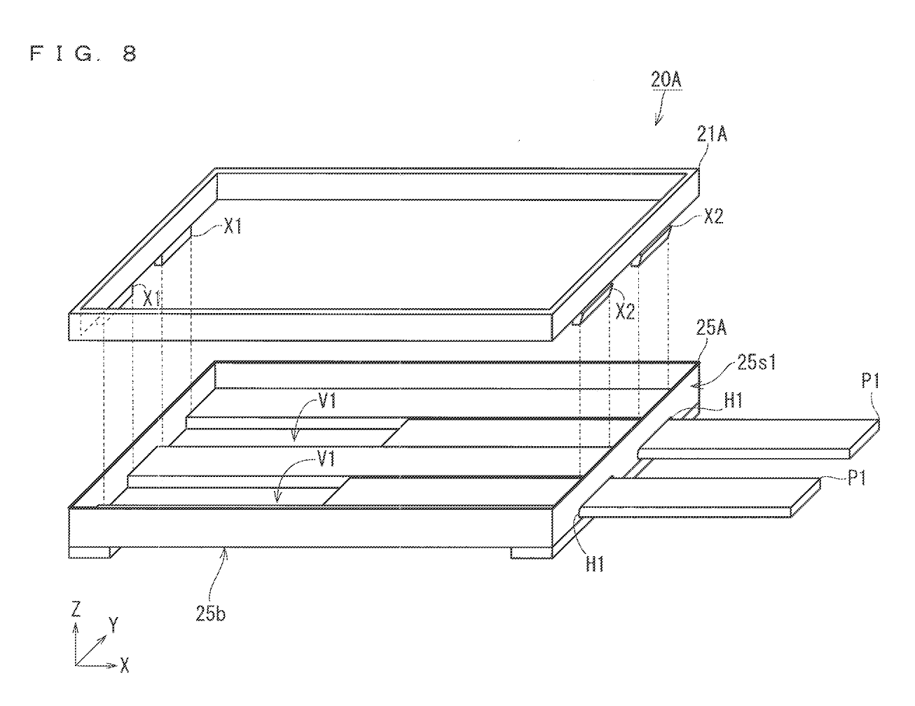

FIG. 8 is an exploded perspective view of the backlight 20A according to a second preferred embodiment of the present invention. To provide the easy-to-understand illustration of the configuration of this preferred embodiment, the optical sheet part 22, the light guide plate 23, the reflecting plate 24, and the light source substrate 26 included in the backlight 20A are omitted in FIG. 8 as in FIG. 3.

Unlike the backlight 20 in FIG. 3, the backlight 20A includes a frame 21A in place of the frame 21 and includes a frame 25A in place of the frame 25. The configuration of the backlight 20A except for the above is the same as that of the backlight 20, and the detailed description thereof is not repeated.

The backlight 20A is configured such that a plurality of plates P1 are removably attached thereto. As an example, FIG. 8 shows the configuration including two plates P1. Each of the plates P1 has the same configuration and the same shape as those of the plate P1 in the first preferred embodiment. While being parallel to each other, the two plates P1 are attached to the backlight 20A. The edge (the side surface P1sa) of the individual plate P1 is fixed to the projecting portion X1 being a part of the frame 21A with the adhesive material NZ2 as in the first preferred embodiment.

Unlike the frame 25, the frame 25A has two grooves V1 and two openings H1. The configuration of the frame 25A except for the above is the same as that of the frame 25, and the detailed description thereof is not repeated.

Each of the two grooves V1 is the groove into which the corresponding one of the two plates P1 is to be fitted. The frame 25A has the two grooves V1 arranged in parallel.

The cover 251 is located in the peripheral portion of the back surface 25b of the frame 25A as in the first preferred embodiment. The cover 251 according to this preferred embodiment has the groove V10 in such a manner that the groove V10 covers the grooves V1. The grooves V1 each have a depth smaller than the thickness (the minimum thickness) of the cover 251.

The side surface 25s1 of the frame 25A has the openings H1 corresponding one-to-one with the grooves V1 as in FIG. 3. Unlike the frame 21, the frame 21A has two pairs of the projecting portions X1 and X2. The configuration of the frame 21A except for the above is the same as that of the frame 21, and the detailed description thereof is not repeated. The pairs of the projecting portions X1 and X2 are provided corresponding one-to-one with the grooves V1.

(Effects)

Each of the two plates P1 is fitted into the corresponding one of the two grooves V1 of the backlight 20A. Thus, the stiffness of the backlight 20A (the display apparatus 100) can be further improved in this preferred embodiment than in the first preferred embodiment. This preferred embodiment produces the effect similar to that of the first preferred embodiment.

### First Modification of Second Preferred Embodiment

In the configuration (hereinafter referred to as “modified configuration B”) of this modification, a plurality of plates are provided so as to cross each other. The backlight 20 having the modified configuration B applied thereto is hereinafter also referred to as “backlight 20B.” The display apparatus in this modification is the display apparatus 100. The display apparatus 100 includes the backlight 20B.

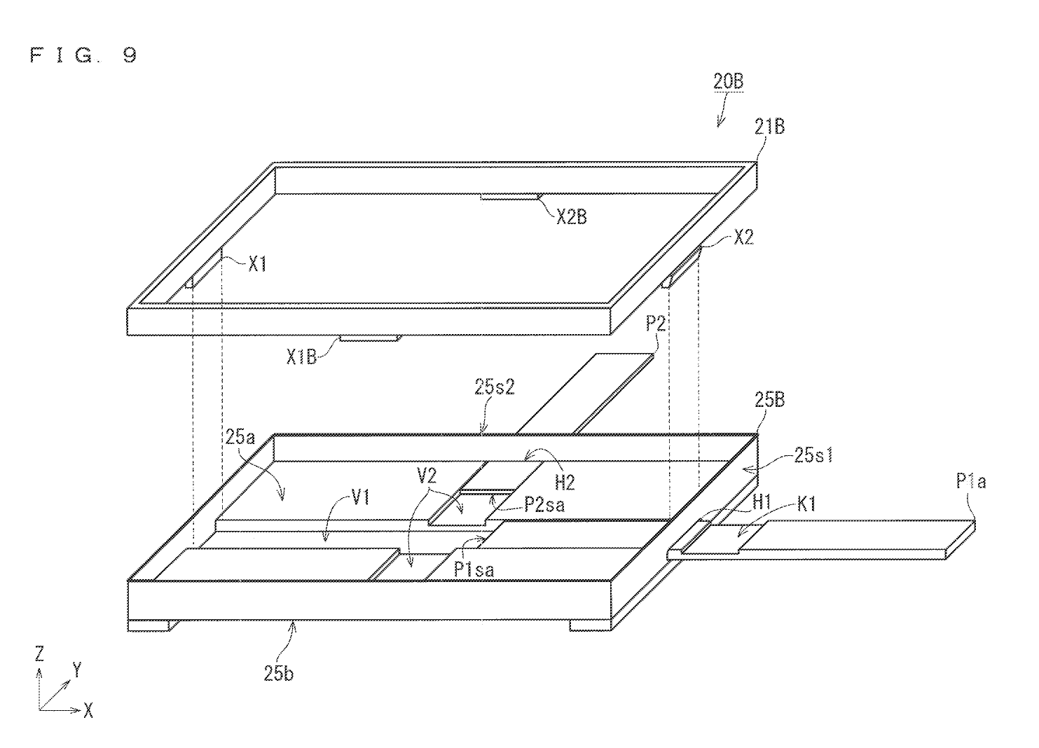

FIG. 9 is an exploded perspective view of the backlight 20B according to a first modification of the second preferred embodiment of the present invention. To provide the easy-to-understand illustration of the configuration of this modification, the optical sheet part 22, the light guide plate 23, the reflecting plate 24, and the light source substrate 26 included in the backlight 20B are omitted in FIG. 9 as in FIG. 3.

Unlike the backlight 20 in FIG. 3, the backlight 20B includes a frame 21B in place of the frame 21 and includes a frame 25B in place of the frame 25. The configuration of the backlight 20B except for the above is the same as that of the backlight 20, and the detailed description thereof is not repeated.

The backlight 20B is configured such that plates P1a and P2 are removably attached thereto.

Unlike the plate P1 in FIG. 3, the plate P1a has a cutout K1 which will be described later. The configuration of the plate P1a except for the above is the same as that of the plate P1, and the detailed description thereof is not repeated. The longitudinal length of the plate P2 is shorter than that of the plate P1 in FIG. 3 and the thickness of the plate P2 is smaller than that of the plate P1 in FIG. 3. The configuration of the plate P2 except for the above is the same as that of the plate P1, and the detailed description thereof is not repeated.

Unlike the frame 25, the frame 25B has the groove V1, a groove V2, the opening H1, and an opening H2. The configuration of the frame 25B except for the above is the same as that of the frame 25, and the detailed description thereof is not repeated.

Each of the grooves V1 and V2 is the groove into which the corresponding one of the plate P1a and the plate P2 is to be fitted. In the frame 25B, the groove V1 is located so as to crosses the groove V2. In particular, the groove V1 and the groove V2 are orthogonal to each other in the midsection of the frame 25B in plan view (in the X-Y plane).

The cover 251 is located in the peripheral portion of the back surface 25b of the frame 25B as in the first preferred embodiment. The cover 251 according to this modification has the groove V10 in such a manner that the groove V10 covers the grooves V1 and V2. The grooves V1 and V2 each have a depth smaller than the thickness of the cover 251.

As described above, the thickness of the plate P2 is smaller than that of the plate P1a. The groove V2 has a depth substantially identical to the thickness of the plate P2. Thus, the depth of the groove V2 into which the plate P2 is to be fitted is smaller than the depth of the groove V1 into which the plate P1a is to be fitted.

The frame 25B has a side surface 25s2. The side surface 25s2 has the opening H2. The opening H2 is the opening for allowing the plate P2 to pass therethrough to fit the plate P2 into the groove V2.

The state in which the plate P1a as a whole is fitted in the groove V1 is hereinafter also referred to as “attached state Pst1.” The state in which the plate P2 as a whole is fitted in the groove V2 is hereinafter also referred to as “attached state Pst2.”

The plate P1a and the plate P2 are used in combination with a clearance in the range of 0 mm to the thickness of the plate P1a left therebetween.

The plate P1a has the cutout K1 in which a part of the plate P2 is fitted in the attached state Pst1 and the attached state Pst2. The cutout K1 is provided in the longitudinal midsection of the plate P1a.

The cutout K1 is provided such that the longitudinal midsection of the plate P2 is fitted in the cutout K1 in the attached state Pst1 and the attached state Pst2. Thus, the cutout K1 has a width substantially identical to the width of the plate P2. The cutout K1 has a depth substantially identical to the thickness of the plate P2. The depth of the cutout K1 is the same as that of the groove V2. The depth of the groove V2 is obtained by subtracting the thickness of the part of the plate P1a in which the cutout K1 is provided from the thickness of the plate P1a (the depth of the groove V1).

The edge portion of the groove V2 on one side is hereinafter also referred to as “groove edge portion V2a.” The groove edge portion V2a is, for example, the lower edge portion of the groove V2 in FIG. 9. The edge portion of the groove V2 on another side is hereinafter also referred to as “groove edge portion V2b.” The groove edge portion V2b is, for example, the upper edge portion of the groove V2. The peripheral portion of the frame 25B (the side surface 25s1) that is in contact with the opening H1 is hereinafter also referred to as “opening peripheral portion B.”

Unlike the frame 21, the frame 21B further includes projecting portions X1B and X2B. The projecting portion X1B has the same shape and the same configuration as those of the projecting portion X1. The projecting portion X2B has the same shape and the same configuration as those of the projecting portion X2.

The projecting portion X1B is the portion which is to be fitted into the groove edge portion V2a. The projecting portion X2B is the portion which is to be fitted into the groove edge portion V2b. Similarly to the projecting portion X2, the projecting portion X2B has the projection Z2. The projection Z2 has a shape for engaging with the opening peripheral portion B of the frame 25B from inside the frame 25B.

The state in which the frame 21B is fixed to the frame 25B is hereinafter also referred to as “frame fixation state Fst2b.” The frame fixation state Fst2b, which includes the frame fixation state Fst1 mentioned above, is the state in which the projecting portion X1B is fitted in the groove edge portion V2a and the projecting portion X2B is fitted in the groove edge portion V2b.

In the frame fixation state Fst2b, the edge (the side surface P1sa) of the plate P1a is fixed to the projecting portion X1 being a part of the frame 21B with the adhesive material NZ2 as in the first preferred embodiment. In the frame fixation state Fst2b, the edge (a side surface P2sa) of the plate P2 is fixed to the projecting portion X1B being a part of the frame 21B with the adhesive material NZ2 as in the first preferred embodiment.

The plates P1a and P2 are attached in the following manner. For easy understanding of the description, the disengaging process and the reengaging process mentioned above are omitted in the following description.

Firstly, the plate P1a as a whole is fitted into the groove V1 as in the first preferred embodiment. Consequently, the groove V2 and the cutout K1 are linearly arranged in the X-Y plane. Then, the operator moves the plate P2 such that the plate P2 passes through the opening H2 and the plate P2 as a whole is fitted into the groove V2 and the cutout K1. Consequently, the plates P1a and P2 are located orthogonal to each other. Thus, the plates P1a and P2 are attached to the backlight 20B.

The plates P1a and P2 are detached from the backlight 20B in the reverse procedure to the above. Firstly, the plate P2 is detached from the groove V2 and the cutout K1. Then, the plate P1 is detached from the groove V1.

(Effects)

As described above, the plates P1a and P2 are located orthogonal to each other in this modification. This improves the stiffness of the backlight 20B in the extending direction of the groove V1 (in the X axis direction) and, at the same time, improves the stiffness of the backlight 20B in the extending direction of the groove V2 (in the Y axis direction). That is, the stiffness of the backlight 20B (the display apparatus 100) can be further improved in the configuration of this modification than in the configuration of the first preferred embodiment. This modification produces the same effect as that of the first preferred embodiment.

The modified configuration N1 mentioned above may he applied to the configuration of this modification. This produces the above-mentioned effect of the modified configuration N1.

### Second Modification of Second Preferred Embodiment

In the configuration (hereinafter also referred to as “modified configuration C”) of this modification, a plurality of plates are provided so as to cross each other. The backlight 20 having the modified configuration C applied thereto is hereinafter also referred to as “backlight 20C.” The display apparatus in this modification is the display apparatus 100. The display apparatus 100 includes the backlight 20C.

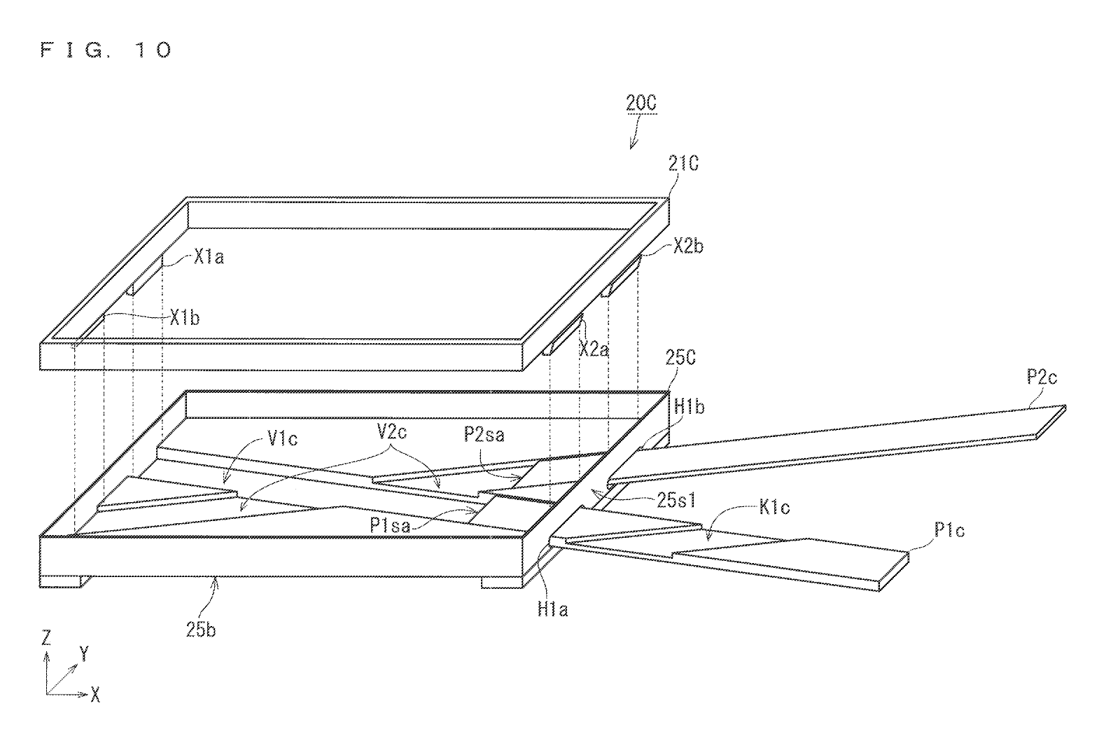

FIG. 10 is an exploded perspective view of the backlight 20C according to a second modification of the second preferred embodiment of the present invention. To provide the easy-to-understand illustration of the configuration of this modification, the optical sheet part 22, the light guide plate 23, the reflecting plate 24, and the light source substrate 26 included in the backlight 20C are omitted in FIG. 10 as in FIG. 3.

Unlike the backlight 20 in FIG. 3, the backlight 20C includes a frame 21C in place of the frame 21 and includes a frame 25C in place of the frame 25. The configuration of the backlight 20C except for the above is the same as that of the backlight 20, and the detailed description thereof is not repeated.

The backlight 20C is configured such that plate P1c and P2c are removably attached thereto.

Unlike the plate P1 in FIG. 3, the plate P1c has a cutout K1c which will be described later and both of the longitudinal edges of the plate P1c are oblique. The configuration of the plate P1c except for the above is the same as that of the plate P1, and the detailed description thereof is not repeated.

The longitudinal length of the plate P2c is greater than that of the plate P2 in FIG. 9 and both of the longitudinal edges of the plate P2c are oblique. The configuration of the plate P2c except for the above is the same as that of the plate P2, and the detailed description thereof is not repeated. That is, the plate P2c has the same thickness as that of the plate P2. Thus, the thickness of the plate P2c is smaller than that of the plate P1c.

Unlike the frame 25 in FIG. 3, the frame 25C has a groove V1c, a groove V2c, an opening H1a, and an opening H1b. The configuration of the frame 25C except for the above is the same as that of the frame 25, and the detailed description thereof is not repeated.

Each of the grooves V1c and V2c is the groove into which the corresponding one of the plate P1c and the plate P2c is to be fitted. In the frame 25C, the groove V1c is located so as to cross the groove V2c, in particular, the groove V1c and the groove V2c cross each other diagonally in the midsection of the frame 25C in plan view (in the X-Y plane).

The cover 251 is located in the peripheral portion of the back surface 25b of the frame 25C as in the first preferred embodiment. The cover 251 according to this modification has the groove V10 in such a manner that the groove V10 covers the grooves V1c and V2c. The grooves V1c and V2c each have a depth smaller than the thickness of the cover 251.

As described above, the thickness of the plate P2c is smaller than that of the plate P1c. The groove V2c has a depth substantially identical to the thickness of the plate P2c. Thus, the depth of the groove V2c into which the plate P2c is to be fitted is smaller than the depth of the groove V1c into which the plate P1c is to be fitted.

The side surface 25s1 of the frame 25C has the openings H1a and H1b. The opening H1a is the opening for allowing the plate P1c to pass therethrough to fit the plate P1c into the groove V1c. The opening H1b is the opening for allowing the plate P2c to pass therethrough to fit the plate P2c into the groove V2c.

The state in which the plate P1c as a whole is fitted in the groove V1c is hereinafter also referred to as “attached state Pst1c.” The state in which the plate P2c as a whole is fitted in the groove V2c is hereinafter also referred to as “attached state Pst2c.”

The plate P1c and the plate P2c are used in combination with a clearance in the range of 0 mm to the thickness of the plate P1c left therebetween. Similarly to the two diagonals of the shape (rectangle) of the frame 25C in plan view (in the X-Y plane), the plate P1c and the plate P2c are used in such a manner that the plate P1c and the plate P2c diagonally cross each other.

The plate P1c has the cutout K1c in which a part of the plate P2c is fitted in the attached state Pst1c and the attached state Pst2c. The cutout K1c is provided in the longitudinal midsection of the plate P1c.

The cutout K1c is provided such that the longitudinal midsection of the plate P2c is fitted in the cutout K1c in the attached state Pst1c and the attached state Pst2c. Thus, the cutout K1c extends obliquely relative to the longitudinal direction of the plate P1c. The cutout K1c has a width substantially identical to the width of the plate P2c. The cutout K1c has a depth substantially identical to the thickness of the plate P2c. The depth of the cutout it K1c is the same as that of the groove V2c.

The edge portion of the groove V1c on one side is hereinafter also referred to as “groove edge portion V1ca.” The groove edge portion V1ca is, for example, the left edge portion of the groove V1c in FIG. 10. The edge portion of the groove V1c on another side is hereinafter also referred to as “groove edge portion V1cb.” The groove edge portion V1cb is, for example, the right edge portion of the groove V1c. The edge portion of the groove V2c on one side is hereinafter also referred to as “groove edge portion V2ca.” The groove edge portion V2ca is, for example, the left edge portion of the groove V2c in FIG. 10. The edge portion of the groove V2c on another side is hereinafter also referred to as “groove edge portion V2cb.” The groove edge portion V2cb is, for example, the right edge portion of the groove V2c.

The peripheral portion of the frame 25C (the side surface 25s1) that is in contact with the opening H1a is hereinafter also referred to as “opening peripheral portion Ca.” The peripheral portion of the frame 25C (the side surface 25s1) that is in contact with the opening H1b is hereinafter also referred to as “opening peripheral portion Cb.”

Unlike the frame 21, the frame 21C includes projecting portions X1a, X1b, X2a, and X2b in place of the projecting portions X1 and X2. The projecting portions X1a and X1b each have the same shape and the same configuration as those of the projecting portion X1 in FIG. 3. The projecting portions X2a and X2b each have the same shape and the same configuration as those of the projecting portion X2 in FIG. 3.

The projecting portion X1a is the portion which is to be fitted into the groove edge portion V1ca. The projecting portion X1b is the portion which is to be fitted into the groove edge portion V2ca. The projecting portion X2a is the portion which is to be fitted into the groove edge portion V1cb. The projecting portion X2b is the portion which is to be fitted into the groove edge portion V2cb.

Similarly to the projecting portion X2, the projecting portions X2a and X2b each have the projection Z2. The projection Z2 of the projecting portion X2a has a shape for engaging with the opening peripheral portion Ca of the frame 25C from inside the frame 25C. The projection Z2 of the projecting portion X2b has a shape for engaging with the opening peripheral portion Cb of the frame 25C from inside the frame 25C.

The state in which the frame 21C is fixed to the frame 25C is hereinafter also referred to as “frame fixation state Fst3C.” The frame fixation state Fst3C is the state in which each of the projecting portions X1a. and X1b is fitted in corresponding one of the groove edge portions V1ca and V2ca and each of the projecting portions X2a and X2b is fitted in the corresponding one of the groove edge portions V1cb and V2cb.

In the frame fixation state Fst3C, the edge (the side surface P1sa) of the plate P1c is fixed to the projecting portion X1a being a part of the frame 21C with the adhesive material NZ2 as in the first preferred embodiment. In the frame fixation state Fst3C, the edge (the side surface P2sa) of the plate P2c is fixed to the projecting portion X1b being a part of the frame 21C with the adhesive material NZ2 as in the first preferred embodiment.

The plates P1c and P2c are attached in the following manner. For easy understanding of the description, the disengaging process and the reengaging process mentioned above are omitted in the following description.

Firstly, the operator moves the plate P1c such that the plate P1c as a whole passes through the opening H1a and the plate P1c as a whole is fitted into the groove V1c. Consequently, the groove V2c and the cutout K1c are linearly arranged in the X-Y plane.

Then, the operator moves the plate P2c such that the plate P2c passes through the opening H1b and the plate P2c as a whole is fitted into the groove V2c and the cutout K1c. Consequently, the plates P1c and P2c are located so as to diagonally cross each other. Thus, the plates P1c and P2c are attached to the backlight 20C.

The plates P1c and P2c are detached from the backlight 20C in the reverse procedure to the above. Firstly, the plate P2c is detached from the groove V2c and the cutout K1c. Then, the plate P1c is detached from the groove V1c.

(Effects)

As described above, the plates P1c and P2c are located so as to diagonally each other in this modification. This improves the stiffness in the torsion that causes two opposed corner portions of the frame 25C to move in the same direction (for example, upwardly). The two opposed corner portions are, for example, the upper-left corner portion and the lower-right corner portion of the frame 25C. This modification also improves the stiffness in the flexure that causes two opposed corner portions of the frame 25C to move closer to each other.

That is, the stiffness of the backlight 20C (the display apparatus 100) can be further improved in the configuration of this modification than in the configuration of the first preferred embodiment. This preferred embodiment produces the same effect as that of the first preferred embodiment.

In the present invention, the above preferred embodiments and the modifications thereof can be arbitrarily combined, or each preferred embodiment and each modification thereof can he appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A backlight configured such that a plate having an elongated shape is removably attached thereto, said backlight comprising:
a first frame that houses a light source; and
a second frame that engages with said first frame, wherein
said first frame has a groove into which said plate is to be fitted, and
said first frame further has an opening for allowing said plate to pass therethrough to fit said plate into said groove.

2. The backlight according to claim 1, wherein an edge of said plate is fixed to a part of said second frame with an adhesive material while said plate is fitted in said groove.

3. The backlight according to claim 1, wherein
said first frame has:
a main surface having said groove; and
a back surface being a surface of said first frame opposite to said main surface,
to said first frame, a cover that covers said back surface is fixed, and
said groove has a depth smaller than a thickness of said cover.

4. The backlight according to claim 1, wherein
said backlight is configured such that another plate having an elongated shape is removably attached thereto, and
said first frame has another groove into which said another plate is to be fitted.

5. The backlight according to claim 4, wherein
said groove is located so as to cross said another groove, and
said plate has a cutout in which a part of said another plate is fitted while said plate is fitted in said groove and said another plate is fitted in said another groove.

6. The backlight according to claim 1, wherein said plate is made of any one of stainless steel, aluminum, steel, and magnesium.

7. The backlight according to claim 1, wherein said plate is made of carbon fiber resin composed of carbon fiber and resin.

8. A display apparatus comprising:
said backlight according to claim 1; and
a display panel located on a light-emitting surface side of said backlight.
